(19) United States
(12) Patent Application Publication
(10) Pub. No.: US 2009/0211681 A1
(43) Pub. Date: Aug. 27, 2009

(54) TIRE AND TIRE RIM ASSEMBLY

(76) Inventors: Richard L. Palinkas, Northfield, CT (US); Ian Laskowitz, Woodbury, CT (US); George H. Nybakken, Middlebury, CT (US)

Correspondence Address: PATENT ADMINISTRATOR;CHEMTURA CORPORATION, 199 Benson Road, Middlebury, CT, 06749, US

(21) Appl. No.: 12/036,964

(22) Filed: Feb. 25, 2008

(51) Int. Cl. B60C 7/24; B60C 25/00; B60B 21/00

(52) U.S. Cl. 152/323; 152/11; 152/326

(57) ABSTRACT

A tire rim for a non-pneumatic tire. The tire rim has an outer hoop that slideably engages a mounting ring disposed on the non-pneumatic tire. The mounting ring is slideably engaged in a lateral direction on the outer hoop. The rim and mounting ring can be secured using one or more mounting plates. The rim allows for the non-pneumatic tire to be easily mounted and removed.

### BACKGROUND OF THE INVENTION

1. Field of the Invention

This invention relates to a tire and a tire rim.

2. Discussion of the Background Information

Tire rims provide a connection between tires and the vehicle. Conventional rims 12 have opposing flanges 16 on each side of an outer hoop 18 to secure the tire 14 to the rim 12 as shown in FIGS. 1A and 1B. Inflatable tires 14, such as radial or bias tires, as shown in FIG. 1A, commonly have beads 20 that engage the flange 16 of the rim 12 to form wheel 10. Conventional non-pneumatic tires 14, shown in FIG. 1B, also have flanges 16 and the tire 14 can be directly molded on the rim 12 or adhered to the rim 12. The flanges 16 for non-pneumatic tires 14 provide a structure to assist in molding or adhering the tire 14 to the rim 12. Also, these flanges prevent the lateral movement of the tire with respect to the rim. It would be desirable to be able to replace either the rims or tires without having to replace the entire wheel, such as when the rim or tire is damaged or worn out. Inflatable radial tires can be deflated and removed by flexing the bead over the flanges using a tool. Non-pneumatic tires, on the other hand, typically cannot be flexed over the flange in a similar fashion, thus making tire removal difficult. If a conventional non-pneumatic tire is to be removed, the tire must be cut away from the rim, which is time consuming and may damage the tire or rim. The cutting may also be difficult due to the presence of the flanges. Due to the difficulties in removing non-pneumatic tires from such rims, conventional damaged tires require the replacement of both the rim and the tire.

In addition, molding a non-pneumatic tire directly to a rim requires that the mold for the tire must include a space for the rim. Typically, the rim functions as part of the mold and defines the inner wall of the tire. Such limitations increase the difficulties to manufacture a tire molded to a rim. Also, molded tires and their associated rims are cumbersome to handle.

Thus, the need exists for a tire rim for non-pneumatic tires that overcomes the shortcomings of the prior art.

### SUMMARY OF THE INVENTION

In a first aspect of the present invention, there is provided a tire rim comprising a central support structure disposed about an axis of rotation, and an outer hoop surrounding the central support structure. The outer hoop comprises a receiving side having a first radial width and a non-receiving side having a second radial width, wherein the first radial width is less than the second radial width to allow a mounting ring disposed on an inner surface of a tire to engage the tire rim laterally from the receiving side.

In a second aspect of the present invention, there is provided a tire mounting system comprising a tire disposed on a mounting ring and a tire rim. The tire rim comprises a central support structure. The tire further comprises an outer hoop surrounding the central support structure and the outer hoop comprises a receiving side having a first radial width and a non-receiving side having a second radial width, wherein the first radial width is less than the second radial width to allow the mounting plate to engage the tire rim laterally from the receiving side.

In a third aspect of the present invention, there is provided a method for mounting a tire comprising (a) disposing a mounting ring on an inner surface of the tire; and (b) slideably engaging the mounting ring onto an outer surface of a rim. The rim has a receiving side and a non-receiving side, the receiving side having a radial thickness that is less than the radial thickness of the non-receiving side and the mounting ring is slideably engaged in a substantially lateral direction from the receiving side until the mounting ring is flush with the radial plane of the non-receiving side.

In a fourth aspect of the present invention, there is provided a non-pneumatic tire assembly, comprising a non-pneumatic tire having an inner circumferential surface mounted on a mounting ring. The mounting ring comprises an inner side having a first radial width and a non-receiving side having a second radial width. The first radial width is less than the second radial width to allow an outer hoop disposed on a central support structure of a tire rim to laterally engage the tire rim.

In some embodiments of the present invention, an off-the-road vehicle comprises a tire rim according to the aspects and embodiments of the present invention.

### BRIEF DESCRIPTION OF THE DRAWINGS

The foregoing and other objects and advantages of our invention will appear more fully from the following description, made in connection with the accompanying drawings of non-limiting preferred embodiments of the inventions, wherein like characters refer to the same or similar parts throughout the views, and in which:

FIG. 1A is a cross sectional view of a conventional radial tire;

FIG. 1B is a cross sectional view of a conventional non-pneumatic tire;

FIG. 2A is a side view of a tire rim constructed in accordance with one embodiment of the present invention;

FIG. 2B is a cross sectional view of the tire rim in FIG. 2A;

FIG. 2C is a cross sectional view of the tire rim in FIG. 2B;

FIG. 2D is a cross sectional view of a rim according to another embodiment of the present invention;

FIG. 3A is a side view of a tire mounted on a tire rim constructed in accordance with an embodiment of the present invention;

FIG. 3B is a detailed cross sectional view of the tire rim in FIG. 3A;

FIG. 3C is an exploded view showing one embodiment of the rim and one embodiment of the tire of the present invention;

FIG. 4A is a perspective view of a tire rim and mounting ring each having trenches in accordance with an embodiment of the present invention; and

FIG. 4B is a perspective view of mounting plates installed in the trenches shown in FIG. 4A.

### DETAILED DESCRIPTION OF THE INVENTION

In one embodiment, the present invention relates to a tire rim having an outer hoop for laterally receiving a mounting ring of a tire. The tire rim has a receiving side and a non-receiving side, which are also generally referred to as the outer side and the inner side, respectively. The outer side refers to the side of the rim that faces away from the vehicle to which the rim is mounted and the inner side refers to the side that faces toward the vehicle. The outer side has a radial thickness that is less than the inner side. The mounting ring is slideably engaged on the rim in the lateral direction from the outer side to the inner side. During installation, the mounting ring of a tire moves laterally onto the rim until the receiving side of the mounting ring is flush with the inner side of the rim such that the ring does not extend past the radial plane of the inner side of the rim. Once in place, the tire is removably secured to the rim, for example, with retaining bolts. To remove the tire, the tire is unsecured and is moved laterally in an opposite direction of the mounting direction. As used herein, the term “lateral” and variations thereof refers to the direction substantially parallel to the axis of rotation of the tire or tire rim. The term “radial plane” refers to a plane that is perpendicular to the axis of rotation. The term “centerline” refers to the radial plane that is oriented at the lateral midpoint of the tire or tire rim.

In another embodiment, the invention relates to a tire suitable for mating with the above-described rim. The tire preferably includes a mounting ring disposed on an inner surface of the tire and comprising a receiving side having a first radial width and a non-receiving side having a second radial width. The first radial width is less than the second radial width to allow the ring to laterally engage the outer hoop of the tire rim.

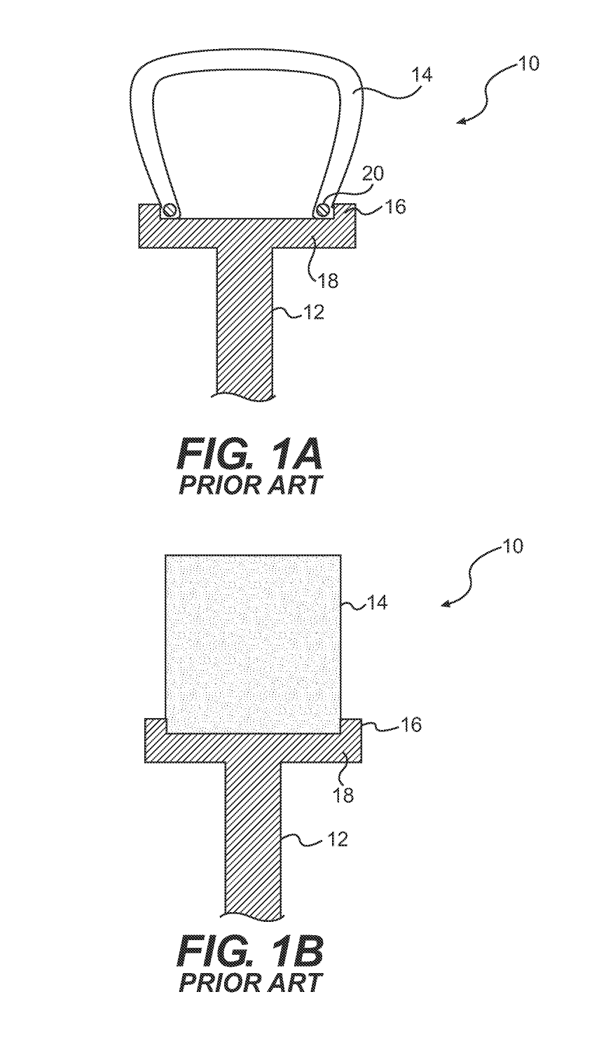

The rim of the present invention preferably lacks conventional flanges (shown in FIGS. 1A and 1B) and thus does not require the rim or tire to be deformed when mounting or removing the tire. This allows the tires to retain their operational configuration, i.e., the configuration in which the tire is intended to be used, throughout the mounting process. Further, no tools are necessary to pry the tire over the flange. Non-pneumatic tires are generally solid tires that have limited flexibility and are not well-suited for being pried over a flange without causing damage to the tire. While such tires may be resilient, such resiliency typically relates to the ability of the tire to locally buckle and withstand strain in a direction within the radial plane. Thus, one would have to deform or flex the non-pneumatic tire, i.e., move in a non-lateral direction, to mount or remove the tire on a conventional rim having flanges. Such movements could damage a non-pneumatic tire and cause the non-pneumatic tire to permanently lose its operational configuration.

Rims of the present invention have an outer hoop that slideably engages a corresponding tire or tire mounting ring to facilitate mounting and removal of the tire to the rim. As used herein, the term “slideably engage” refers to lateral movement of the mounting ring of the tire with respect to the outer hoop of the tire rim. During the mounting step, the mounting ring is moved laterally from one edge of the rim to the other, i.e. from outer side to inner side, until the outer surface of the outer hoop engages the mounting ring and ceases movement thereof. Preferably, lateral movement of the tire is stopped when the mounting ring is flush with the radial plane of the inner side of the rim. When the mounting ring initially slideably engages the rim, the mounting ring may not directly contact the entire circumference of the rim. Instead, the mounting ring may directly contact a portion of the outer surface of the rim and slide along that portion until the mounting ring engages the entire outer surface of the rim. In this manner, the mounting ring slideably engages the rim until fully engaged, i.e., the full inner surface of the mounting ring is in contact with the outer surface of the rim.

In one embodiment, the present invention comprises a rim with a tapered design, i.e. a sloping outer surface, which reduces the frictional force required for installation. In conventional “press-on” rims a jack or press is used to force the tire onto the rim. This creates an interference fit. However, for larger wheels, having an outside diameter greater than 0.5 m, e.g. greater than 1.0 m or greater than 2.0 m, the amount of force required to press the tire onto the rim would be expensive and inefficient. In such embodiments, the sloping outer surface of the rim reduces or eliminates the frictional force.

Embodiments of the present invention are particularly suited to off-the-road (OTR) vehicles, also referred to as off-highway vehicles. OTR vehicles are commonly used in rugged terrain for mining, excavation, construction, military applications, and other heavy industrial applications. OTR vehicles include, for example, tractors, trucks, loaders, dozers, graters, and excavators and may have operational weights as high as 380 to 460 tons. Such vehicles may have non-pneumatic tires as described in co-pending U.S. Ser. No. 12/______, entitled “NON-PNEUMATIC TIRE,” filed Feb. 25, 2008 (attorney docket no. 2008P005.US ), the entirety of which is incorporated herein by reference. Embodiments of the present invention are particular suited to OTR vehicles having non-pneumatic tires because of the ease of the slideably engaging assembly and removal of the tire from the rim.

The dimensions of the rims and tires of the present invention may vary widely, depending primarily on their intended application. The tires of such vehicles are typically very large compared to passenger vehicles and have inner diameters that may be greater than 0.5 m, e.g., greater than 1.0 m or greater than 2.0 m. In terms of ranges, the tires may have inner diameters of, for example, from 0.5 to 3.6 m, e.g., from 0.8 to 2.8 m, or from 1.0 to 2.0 m. For purposes of the tires of the present invention, the inner diameter is smallest inner diameter of the tire, typically the outer diameter at the outer surface of the mounting ring. Similarly, the rims of the present invention preferably are suited for laterally mating with the tires of the present invention, as discussed above. Accordingly, the rims optionally have an outer diameter that is greater than 0.5 m, e.g., greater than 1.0 m or greater than 2.0 m. In terms of ranges, the rim may have an outer diameter of, for example, from 0.5 to 3.6 m, e.g., from 0.8 to 2.8 m, or from 1.0 to 2.0 m. For purposes of the present specification, the outer diameter of a rim is the greatest outer diameter thereof, typically the outer diameter at the inner surface of the rim. The tires optionally have an outer diameter that is greater than 0.6 m, e.g., greater than 1.5 m or greater than 3.5 m. In terms of ranges, the tires optionally have an outer diameter that is from 0.6 to 4.8 m, e.g., from 1.5 m to 4.0 m, or from 1.6 to 2.5 m.

Although embodiments of the present invention will be described in terms of larger tires, the rim assemblies of the present invention may also be used with tires having an outside diameter of 1.25 inches (3.2 cm) to 19.75 inches (50 cm) and an inside diameter of 1 inch (2.6 cm) to 19.75 inches (50 cm). An sloping outer surface on such rims may also reduce the frictional forces requires to mounted such smaller tires.

The non-pneumatic tires of the present invention that are capable of being secured to the rims of the present invention include those made from elastomeric materials, such as those described in U.S. Pat. No. 4,832,098, U.S. Pat. No. 4,934,425, U.S. Pat. No. 4,921,029, U.S. Pat. No. 4,784,201, U.S. Pat. No. 5,605,657, and U.S. application Ser. No. 09/919,994, filed on Aug. 2, 2001, the entire contents and disclosure of which are hereby incorporated by reference. One exemplary material may be a polyurethane elastomer comprising a prepolymer formed from a diisocyanate and a polyol, e.g. polycaprolactone, polyester, poly(tetramethylene ether) glycol (PTMEG), etc., that is cured with diamine curative such as 4,4′-methylene-bis(2-chloroaniline) (MBCA); 4,4′-methylene-bis(3-chloro-2,6-diethylaniline (MCDEA); diethyl toluene diamine (DETDA; Ethacure™ 100 from Albemarle Corporation); tertiary butyl toluene diamine (TBTDA); dimethylthio-toluene diamine (Ethacure™ 300 from Albemarle Corporation); trimethylene glycol di-p-amino-benzoate (Vibracure™ A157 from Chemtura Company, Inc. or Versalink™ 740M from Air Products and Chemicals); methylene bis orthochloroaniline (MOCA), methylene bis diethylanaline (MDEA); methylenedianiline (MDA); and MDA-sodium chloride complex (Caytur™ 21 and 31 from Chemtura Company). Exemplary elastomeric materials suitable for non-pneumatic tires include polyurethanes such as those formed from commercially available Adiprene™ polyurethane prepolymers and Caytur™ diamine curatives from Chemtura Corp., a segmented copolyester such as Hytrel 5556 from DuPont, a reaction injection molded material, and a block copolymer of nylon such as Nyrim from Monsanto Chemical Co. In this disclosure, polyurethane elastomer refers to a polymer with urethane linkages (derived from an isocyanate group and a hydroxyl group) and optionally, urea linkages as well (derived from an isocyanate group and an amine group). Examples of such polyurethane elastomers are disclosed in U.S. Pat. Nos. 5,077,371, 5,703,193, and 6,723,771, and U.S. application Ser. No. 11/702,787, filed on Feb. 5, 2007, the entire contents and disclosure of which are hereby incorporated by reference.

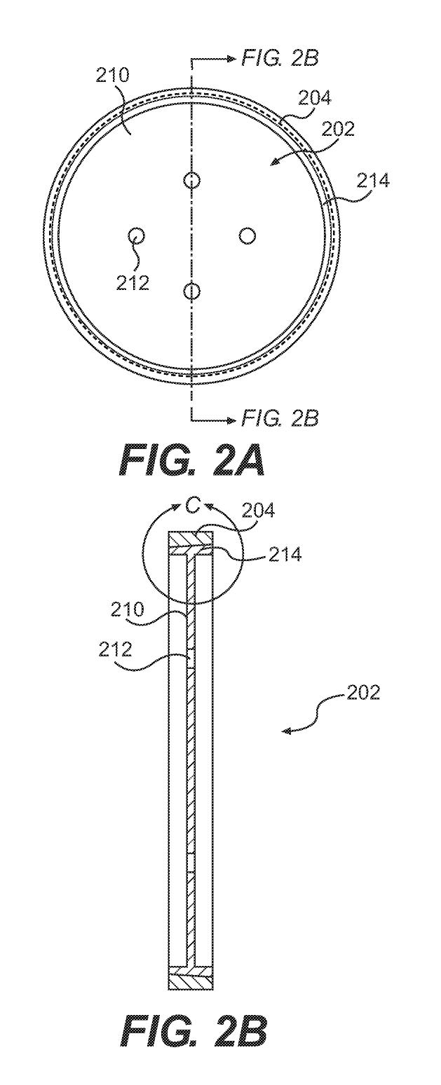

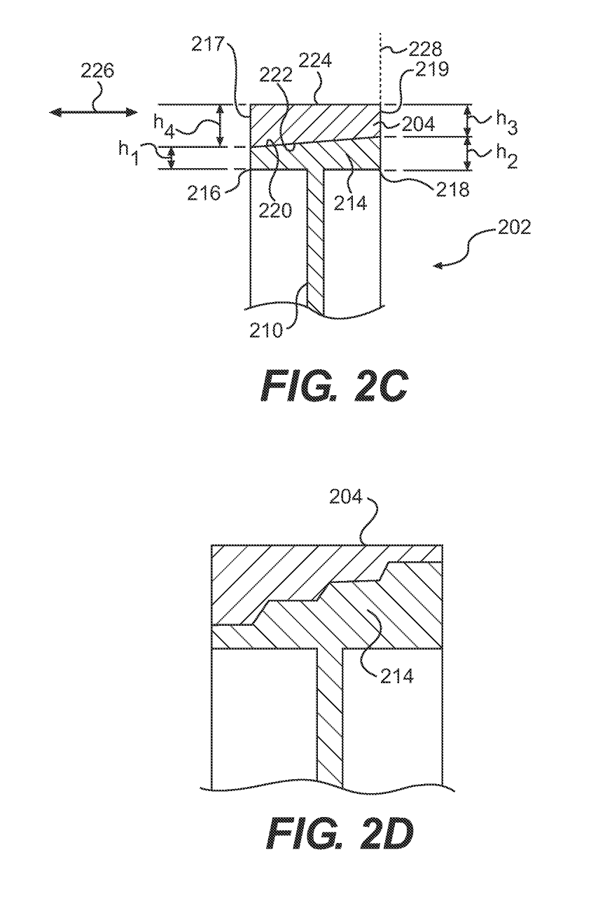

FIGS. 2A, 2B and 2C illustrate an exemplary tire mounting ring 204 mounted to tire rim 202 in accordance with an embodiment of the present invention (for clarity, FIGS. 2A-2C do not show a tire mounted on mounting ring 204). Mounting ring 204 may be directly molded or adhered, using a suitable adhesive or bonding agent, to a non-pneumatic tire. In one aspect, one or more flanges for securing the tire are provided on outer surface 224 of mounting ring 204.

Rim 202 comprises a central support system 210, as shown, a rigid circular plate, having mounting holes 212 and an outer hoop 214 affixed, e.g., welded, on or integrally formed with the central support system 210. Outer hoop 214 comprises an outer side 216 and an inner side 218. The radial thickness (h₁) of outer side 216 is less than the radial thickness (h₂) of inner side 218. An outer sloping surface 220 extends along the outer circumference from outer side 216 to inner side 218 of outer hoop 214. Tire mounting ring 204 has an inner sloping surface 222 that inversely corresponds to outer sloping surface 220 of outer hoop 214, and an outer circumferential surface 224 that is molded directly or adhered to a tire (not shown). Tire mounting ring 204 also includes an inner side 219 having radial thickness (h₃) and an outer side 217 having radial thickness (h₄). The radial thickness (h₄) of outer side 217 is greater than the radial thickness (h₃) of inner side 219. Tire mounting ring 204 can travel in a lateral direction, represented by arrow 226, until inner side 219 of mounting ring 204 is flush with the radial plane 228 of inner side 218 of the rim 202.

Rim 202 and mounting ring 204 may be constructed, for example, from steel, aluminum, reinforced fiberglass plastics, metallic alloys, or combinations thereof. In one embodiment, both the rim 202 and mounting ring 204 are constructed of steel. The radial thickness (h₁) of outer side 216 of outer hoop 214 may be approximately 5 to 50 cm, e.g., 10 to 40 cm, or 15 to 35 cm. Radial thickness (h₂) of inner side 218 of outer hoop 214 may be, for example, from 2 to 50 cm, e.g., from 2 to 30 cm, or from 5 to 25 cm greater than (h₁). Similarly, the radial thickness (h₃) of inner side 219 of mounting ring 204 may be approximately 5 to 50 cm, e.g., 10 to 40 cm, or 15 to 35 cm. Radial thickness (h₄) of outer side 217 of mounting ring 204 may be, for example, from 2 to 50 cm, e.g., from 2 to 30 cm, or from 5 to 25 cm greater than (h₃).

The width of the tire or tire rim similarly may vary widely. Mounting ring 204 preferably has substantially the same width as outer hoop 214 of rim 202. In some exemplary embodiments, the rim or tire has a width greater than 0.4 m, e.g., greater than 0.8 m, or greater than 1.2 m. In terms of ranges, the tire or tire rim optionally has a width ranging from 0.4 m to 1.8 m, e.g., from 0.5 to 1.5 m, or from 0.66 to 0.74 m.

Central support system 210 is disposed about the axis of rotation and may have a variety of configurations, well known to those skilled in the art, and may have one or more spokes, axle mounts, mounting holes, etc., for securing the rim to a vehicle, e.g., OTR vehicle. Suitable configurations should provide structural rigidity to reduce tire deflection of the rim during operation. For example rim 202 may have a configuration as shown in U.S. Pat. No. 4,784,201, the entire contents and disclosure of which is incorporated herein by reference. The vehicle to which rim 202 is attached may dictate the configuration of central support system 210. Advantageously, the embodiments of the present invention may be used with a variety differently configured central support systems 210, provided that outer hoop 214 is able to slideably engage mounting ring 204, as described herein.

Outer sloping surface 220 of outer hoop 214 and inner sloping surface 222 of mounting ring 204 slideably engage as the tire is mounted onto mounting ring 204. Specifically, the inner sloping surface 222 of mounting ring 204 can slide along outer sloping surface 220 until ring 204 is flush with inner side 218. In this manner, the inner sloping surface 222 and the outer sloping surface 220 guide one another into a mating relationship. At that point outer sloping surface 220 engages inner sloping surface 222 to prevent further lateral movement in the mounting direction. As shown in FIG. 2C, the inner and outer sloping surfaces 222, 220 are preferably smooth and have a uniform surface. The angle of sloping surface 220 preferably is from 1° to 60°, e.g., from 5° to 30°, or from 5° to 15°. In embodiments of the present invention, the angle of sloping surface 220 reduces the frictional force required to mount the tire to rim 202. Of course, other configurations are also possible in which the inner and outer sloping surfaces 222, 220 are not smooth. FIG. 2D, for example, illustrates one embodiment of the present invention in which the inner and outer sloping surfaces 222, 220 have a stair step configuration. The angle of the sloping surface 220 in FIG. 2D is the angle along a line drawn from the outer side to the inner side.

In one embodiment, mounting ring 204 is mounted on to rim 202 using a press or jack. Such mounting may tightly secure the mounting ring 204 to the rim 202 to create an interference fit.

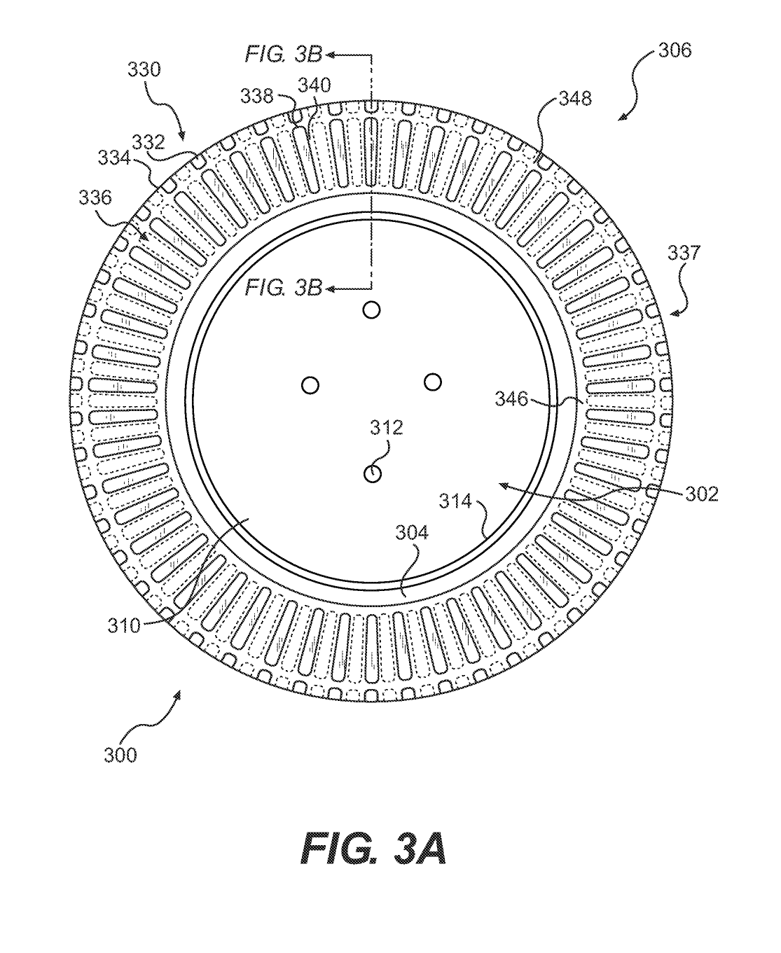

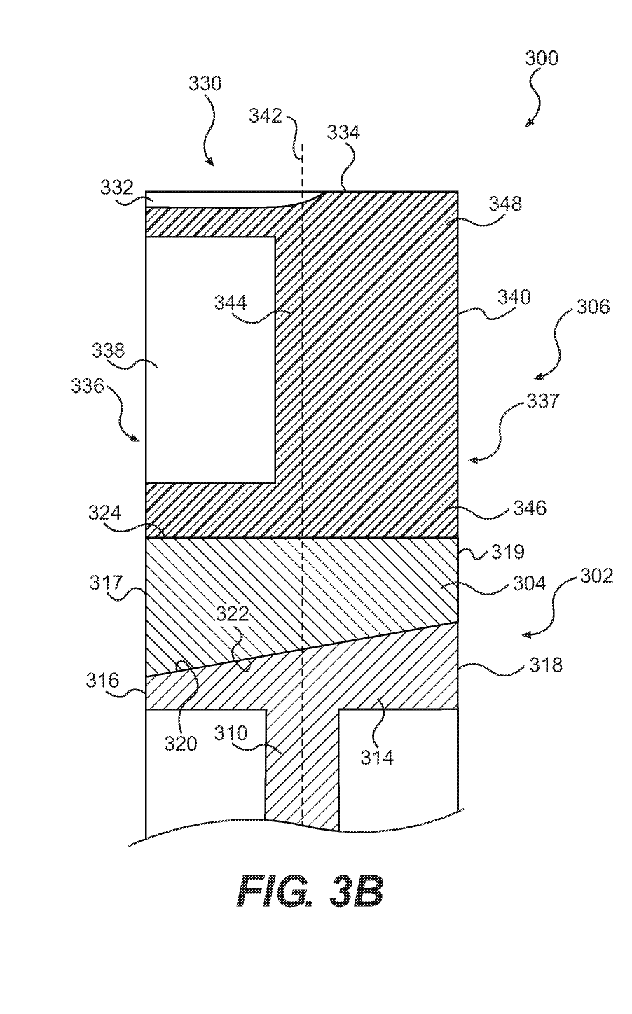

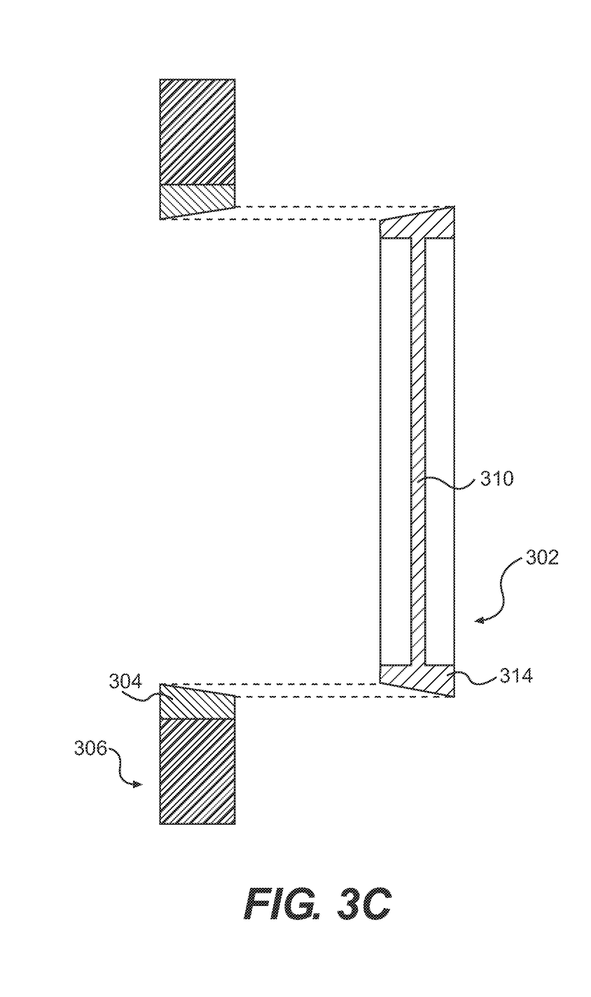

FIGS. 3A and 3B illustrate a non-limiting exemplary wheel 300 having a rim 302 mounted to a tire 306 in accordance with an embodiment of the present invention. FIG. 3C is an exploded view of wheel 300 and rim 302, and for convenience the cavities and grooves of tire 306 are not shown in FIG. 3C. Rim 302 comprises a central support system 310, mounting holes 312, outer hoop 314, outer side 316, inner side 318 and outer sloping surface 320, as discussed above with reference to FIGS. 2A, 2B, and 2C. A mounting ring 304 connects tire 306 to rim 302. In the embodiment shown, mounting ring 304 is directly molded or adhered to tire 306, but removably mounted to rim 302.

Tire 306 is similar to those described in co-pending U.S. Ser. No. ______, entitled “NON-PNEUMATIC TIRE,” filed on Feb. 25, 2008 (attorney docket no. 338004-2008P005.US), the entirety of which is incorporated herein by reference. That specification describes tires having cavities and tire tread grooves that are substantially aligned on the same sidewall and substantially offset with respect to the cavities and tire tread grooves on the other opposing sidewall. Other embodiments include tires having cavities and tread grooves that are substantially offset on the same sidewall and substantially offset with respect to the cavities but aligned with tread grooves on the opposing sidewall. Although the rim of the present invention is described in terms of interacting with the non-pneumatic tire from co-pending U.S. Ser. No. ______, entitled “NON-PNEUMATIC TIRE,” filed on Feb. 25, 2008 (attorney docket no. 338004-2008P005.US), the present invention is not limited thereto. It will be appreciated that other non-pneumatic tire designs may be employed, as well as pneumatic tires.

With reference to FIGS. 3A and 3B, tire 306 comprises a tread pattern 330 having a plurality of tread grooves 332 and tread footprints 334. Tread footprint 334 is the portion of tire pattern 330 that is in contact with the ground or other similar surface. It should be readily understood, that tire pattern 330 is continuous around the outer circumference of tire 306. Tire 306 also comprises two sidewalls 336, 337 each having a plurality of cavities 338 separated by ribs 340. Cavities 338 extend from a plane perpendicular to sidewalls 336, 337 towards a centerline 342. Near centerline 342 is a central web 344. Cavities 338 are separated from rim 302 by inner hoop 346 and from tread pattern 330 by outer hoop 348.

Each tread groove 332 extends laterally across the width of tire 306 and opens near the shoulder region where tread pattern 330 adjoins each sidewall 336, 337. Tread groove 332 does not overlap with rib 340, but does overlap cavity 338 on the same sidewall 336. Grooves 332 alternate along tread pattern 330. Grooves 332 extend in from the shoulder of tire 306 without bending or angling. Other configurations are described in co-pending U.S. Ser. No. ______, entitled “NON-PNEUMATIC TIRE,” filed on Feb. 25, 2008 (attorney docket no. 338004-2008P005.US), previously incorporated by reference.

As shown in FIG. 3A, cavities 338 and ribs 340 extend radially from a centerpoint of tire 306. As used herein the terms radially and radial refer to being in line with a direction that extends perpendicularly from the axis of tire 306. Radial cavities 338 have a substantially oval or trapezoidal shape with the distance between ribs 340 closest to rim 302 is less than the distance between the same ribs 340 closest to tread pattern 330. In one embodiment, as shown in FIG. 3B, each cavity 338 is defined by the inner hoop 346, outer hoop 348 and adjacent ribs 340. Cavities 338 extend inward perpendicular from a plane of sidewall 336 with substantially straight walls.

Cavities 338 on both sidewalls 336, 337 extend into tire 306 towards web 344. On the opposing sidewall 337, cavities 338 are staggered such that ribs 340 on sidewall 336 align with cavities 338 on opposing sidewall 337. Such staggering of cavities 338 reduces the amount of material used in the mold when making tire 306 and reduces the tire weight while maintaining desirable load bearing properties.

In one embodiment as shown in FIG. 3B, each cavity 338 is defined by the inner circumferential member or hoop 346, outer circumferential member or hoop 348 and adjacent ribs 340. Staggered cavities 338 extend inwardly perpendicular to a plane of sidewall 336 with substantially straight walls such that the open area of cavity 338 is approximately equal to the area of the cavity on web 344. In other embodiments, the walls of cavity 338 may be angled or sloped inwardly in which case the area of cavity 338 on web 344 is less than the opening area of cavity 338.

As shown, the staggered cavities 338 and overlapping grooves 332 create a pattern as follows. On one sidewall 336 a cavity 338 is substantially overlapping with groove 332, while the opposing sidewall 337 a rib 340 is substantially overlapping with footprint 334. This alternating pattern between tread pattern 330 and sidewalls 336, 337 repeats for the entire circumference of tire 306.

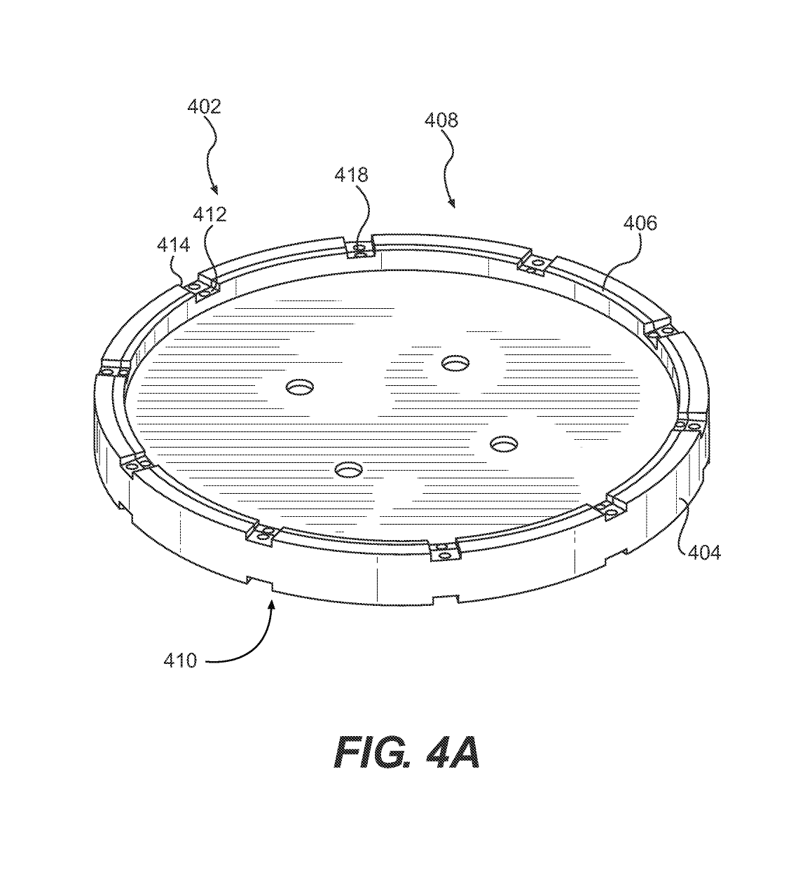

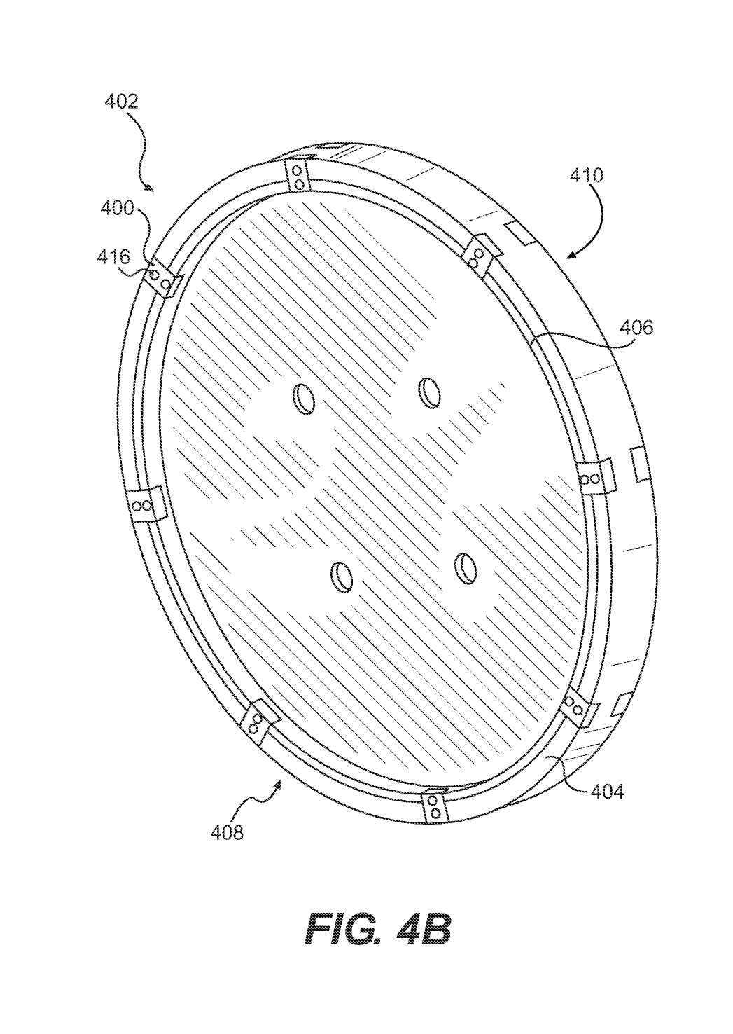

In some embodiments of the present invention there one or more securing devices are provided for securing the mounting ring and rim together. One exemplary securing device is shown in FIGS. 4A and 4B. In this embodiment, a plurality of mounting plates 400 are used to secure the mounting ring 404 to outer hoop 406. FIG. 4A shows rim 402 and mounting ring 404 without mounting plates 400 and FIG. 4B shows the installed mounting plates 400. For clarity, the tire is not shown in FIGS. 4A and 4B. Mounting plates 400 secure mounting ring 404 to rim 402 to prevent undesired lateral movement thereof. In addition mounting plates 400 may assist in properly aligning rim 402 and mounting ring 404 during mounting. On outer hoop 406 of rim 402 there is an outer side 408 and an inner side 410. Along outer side 408 a plurality of trenches 412 are formed such that trenches 412 extend through the entire radial thickness of outer side 408. Also, along inner side 410 a similar number of plurality of trenches 412 are formed in the same fashion as the outer side 408. Mounting ring 404 has a plurality of trenches 414 that correspond to the trenches 412 on outer side 408 and inner side 410. Trenches 414 of mounting ring 404 extend through the entire radial thickness of each side of mounting ring 404. Once mounting ring 404 is mounted onto rim 402, mounting plates 400 are fitted into the aligned trenches 412, 414. A plurality of fasteners 416 are inserted through mounting plates 400 and into holes 418 to secure rim 402 and mounting ring 404 together.

The number of trenches 412 and 414 in rim 402 and mounting ring 404, respectively, can vary, for example, from 3 to 20, e.g., from 5 to 12. Although an equal number of trenches 412 are shown on outer side 408 and inner side 410, in some embodiments, there may be different number of trenches on each side. Also, trenches 412 may be staggered from outer side 408 to inner side 410.

Although trenches 412 and 414 are shown as extending through the radial thickness of both outer hoop 406 of rim 402 and mounting ring 404, in some embodiments trenches 412 and 414 extend partially through the radial thickness. In embodiments in which trench 414 partially extends through the radial thickness, there is provided additional surface area on the outer surface of mounting ring 404. This provides a larger surface area to mount or adhere the tire.

Mounting plates 400 are removably attached using a suitable fastener 416, such as a screw, bolt, and the like. In some embodiments, holes 418 extend through the lateral width of both outer hoop 406 and mounting ring 404. In such embodiments, fasteners 416 extend through holes 418 and are secured at each end. When mounting plates 400 are aligned, fasteners 418 may be used to secure both mounting plates 400. In other embodiments, fasteners 416 secure mounting plates 400 to holes 418 on each side. In other embodiments, fasteners 416 may be integral with mounting plates 400.

In some embodiments, fasteners 416 are used to pull and/or push rim 402 and mounting ring 404 together. Rim 402 and mounting ring 404 may require additional force so that mounting ring 404 is flush with the radial plane of inner side 410.

In one embodiment, mount plates 400 are provided on outer side 408 of rim 402 to prevent lateral movement in an opposite direction as to the mounting direction. In such embodiments, no mounting plates 400 are provided on inner side 410, since the slideably engaging rim 402 and mounting ring 404 are engaged to prevent lateral movement in the mounting direction past the radial plane of inner side 410. Such embodiments are particular suited when rim 402 is mounted on a vehicle such that the receiving side, outer side 408, faces out from the vehicle. This allows a mechanic, for example, to remove mounting ring 404 and tire from the rim 402 easily without having to remove rim 402 from the axel to gain access to inner side 410 which faces toward the vehicle.

In one embodiment, mounting plates 400 are integrally formed on one side of mounting ring 404 such that no trenches 414 in mounting ring 404 are necessary on that side. In other embodiments, mounting plates 400 are integrally formed on an inner side 410 of rim 402 to engage corresponding trenches 414 on mounting ring 404. Such embodiments do not require fasteners 416 to secure mounting plates 400 to mounting ring 404 or outer loop 406, respectively. This may reduce the time to remove and replace the tire.

Although FIGS. 4A and 4B show that mounting plates 400 have a substantially square shape, the shape of mounting plates 400 may vary. Likewise, the shape of trenches 412, 414 may vary to fit the shape of mounting plates 400.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A tire rim, comprising:
a central support structure disposed about an axis of rotation; and
an outer hoop surrounding the central support structure and comprising a receiving side having a first radial width and a non-receiving side having a second radial width, wherein the first radial width is less than the second radial width to allow a mounting ring disposed on an inner surface of a tire to engage the tire rim laterally from the receiving side.

2. The tire rim of claim 1, wherein the outer hoop comprises an outer surface that slopes from the receiving side to the non-receiving side.

3. The tire rim of claim 2, wherein the mounting ring has an inner surface that slideably engages the outer surface, the inner side having an opposing slope from the outer surface.

4. The tire rim of claim 1, further comprising one or more mounting plates to secure the mounting ring to the tire rim on the receiving side.

5. The tire rim of claim 1, wherein the mounting ring cannot laterally move pass a radial plane of the non-receiving side.

6. The tire rim of claim 1, wherein the mounting ring is molded onto a non-pneumatic tire.

7. A tire mounting system, comprising:
a tire disposed on a mounting ring; and
a tire rim comprising:
a central support structure; and
an outer hoop surrounding the central support structure and comprising a receiving side having a first radial width and a non-receiving side having a second radial width, wherein the first radial width is less than the second radial width to allow the mounting plate to engage the tire rim laterally from the receiving side.

8. The tire mounting system of claim 7, wherein the outer hoop comprises an outer surface that slopes from the receiving side to the non-receiving side.

9. The tire mounting system of claim 8, wherein the mounting ring has an inner surface that slideably engages the outer surface, the inner side having an opposing slope from the outer surface.

10. The tire mounting system of claim 7, further comprising one or more mounting plates to secure the mounting ring to the tire rim on the receiving side.

11. The tire mounting system of claim 7, wherein the mounting ring cannot laterally move pass the radial plane of the non-receiving side.

12. The tire mounting system of claim 7, wherein the mounting ring is molded onto the tire.

13. The tire mounting system of claim 7, wherein the tire is a non-pneumatic tire.

14. The tire mounting system of claim 7, wherein the non-pneumatic tire comprises:
opposing sidewalls each having a plurality of radial cavities; and
a tread pattern on an outer circumference of the non-pneumatic tire comprising a plurality of tread grooves, each of the plurality of tread grooves extending from one of the opposing sidewalls is substantially overlapping with one or more of the plurality of the radial cavities on that sidewall.

15. A method for mounting a tire, comprising:
(a) disposing a mounting ring on an inner surface of the tire; and
(b) slideably engaging the mounting ring onto an outer surface of a rim, wherein the rim has a receiving side and a non-receiving side, the receiving side having a radial thickness that is less than the radial thickness of the non-receiving side and the mounting ring is slideably engaged in a substantially lateral direction from the receiving side until the mounting ring is flush with the radial plane of the non-receiving side.

16. The method of claim 15, wherein step (a) comprises molding the mounting ring to the inner surface of the tire.

17. The method of claim 15, wherein the outer surface of the rim has a sloping surface from the receiving side to the non-receiving side that slideably engages an inner surface of the mounting ring.

18. The method of claim 15, further comprising:
(c) securing the mounting ring to the rim when the mounting ring is flush with the rim.

19. The method of claim 15, wherein step (c) comprising attaching one or more mounting plates to the mounting ring and the rim.

20. The method of claim 15, wherein in step (b) the tire retains its operational configuration when the mounting ring is slideably engaged onto the rim.

21. A non-pneumatic tire assembly, comprising:
a non-pneumatic tire having an inner circumferential surface mounted on a mounting ring, wherein the mounting ring comprises an inner side having a first radial width and a non-receiving side having a second radial width, wherein the first radial width is less than the second radial width to allow an outer hoop disposed on a central support structure of a tire rim to laterally engage the tire rim.

22. The tire rim of claim 21, further comprising one or more mounting plates to secure the mounting ring to the tire rim.

23. The tire rim of claim 21, wherein the mounting ring cannot laterally move pass a radial plane of a non-receiving side of the tire rim.

24. The tire rim of claim 21, wherein the mounting ring is molded onto the non-pneumatic tire.
